(19) United States
(12) Patent Application Publication
(10) Pub. No.: US 2009/0242230 A1
(43) Pub. Date: Oct. 1, 2009

(54) Electrical connector canopy

(76) Inventor: Robert J. Hebert, Northeast Albuquerque, NM (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 12/076,883

(22) Filed: Mar. 25, 2008

(51) Int. Cl. H02G 3/14

(52) U.S. Cl. 174/67

(57) ABSTRACT

An electrical connector canopy including a pair of spaced-apart, end walls. A top wall extends between and connects together the end walls. A front wall extends downwardly from and connects to the top wall. The front wall is provided with a number of vertical slots that extend upwardly from the bottom thereof. A resilient sheet is affixed to the front wall. The sheet is provided with a number of elongated openings, each of which extends upwardly along the centerline of a respective one of the slots.

### FIELD OF THE INVENTION

The present invention relates generally to electricity, conductors and insulators, and, more particularly, to covers or face plates with closures for face plate openings.

### BACKGROUND OF THE INVENTION

One popular CDMA base station, the Lucent 4401, is housed in a heavy-duty cabinet. While the cabinet adequately shields its contents from the weather, it does have one weak point: cables that transmit RF communications signals to and from the base station are joined to connectors located on the exterior of the cabinet. These connectors, even when wrapped with insulative materials, are, unfortunately, prone to early failure due to corrosion brought about by the infiltration of precipitation and dirt. Since the loss of signal through a single connector renders a base station inoperative, a serious maintenance challenge is presented to cellular communication providers that utilize Lucent 4401 base stations.

### SUMMARY OF THE INVENTION

In light of the problems associated with the design and maintenance of certain CDMA base stations, it is a principal object of the invention to provide an electrical connector canopy for releasable attachment to the cabinet of a CDMA base station that shields external electrical connectors from: precipitation, airborne dust and dirt, insects, animals, and inadvertent human contact. Thus, a base station utilizing my canopy can be expected to operate longer without the need to repair or replace its associated electrical connectors or cables, saving substantial sums of money.

It is another object of the invention to provide an electrical connector canopy of the type described that can be quickly and easily installed upon a base station cabinet by one person with minimal instruction and without resort to any additional tools. The subsequent operation of the canopy is particularly intuitive.

It is a further object of the invention to provide an electrical connector canopy that, after mounting upon a base station, can be hinged upwardly for access to the covered electrical connectors.

Still another object of the invention is to provide an electrical connector canopy that provides strain relief to the electrical connectors that it covers.

It is an object of the invention to provide improved features and arrangements thereof in an electrical connector canopy for the purposes described that is lightweight in construction, inexpensive to manufacture, long lived, and dependable in use.

Briefly, the electrical connector canopy in accordance with this invention achieves the intended objects by featuring a pair of spaced-apart, end walls and a top wall that extends between and connects together the end walls. A front wall extends downwardly from and is connected to the top wall. The front wall is provided with a number of vertical slots that extend upwardly from the bottom thereof. A resilient sheet is affixed to the front wall and is provided with a number of elongated openings that extend along the centerlines of slots. Each of the elongated openings has a vertical slit and at least one bore, being relatively wider than the slit, which intersects the slit for the snug passage of a cable. A mounting plate, for attachment to a vertical supporting surface, is connected by a hinge to the top wall.

The foregoing and other objects, features, and advantages of my electrical connector canopy will become readily apparent upon further review of the following detailed description of the preferred embodiment shown in the accompanying drawings.

### BRIEF DESCRIPTION OF THE DRAWINGS

The present invention may be more readily described with reference to the accompanying drawings, in which:

FIG. 1 is a perspective view of an electrical connector canopy in accordance with the present invention shown mounted on a telecommunications base station cabinet.

FIG. 2 is a front view of the electrical connector canopy of FIG. 1.

FIG. 3 is a bottom view of the electrical connector canopy.

FIG. 4 is a side view of the electrical connector canopy shown mounted on the base station cabinet and with portions broken away to reveal details thereof.

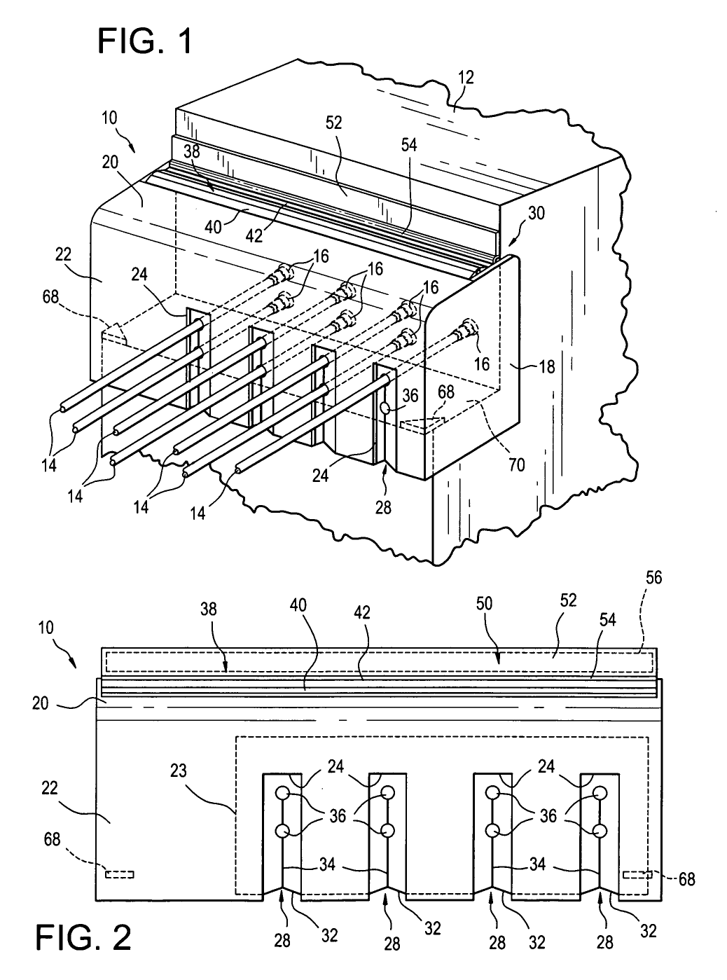

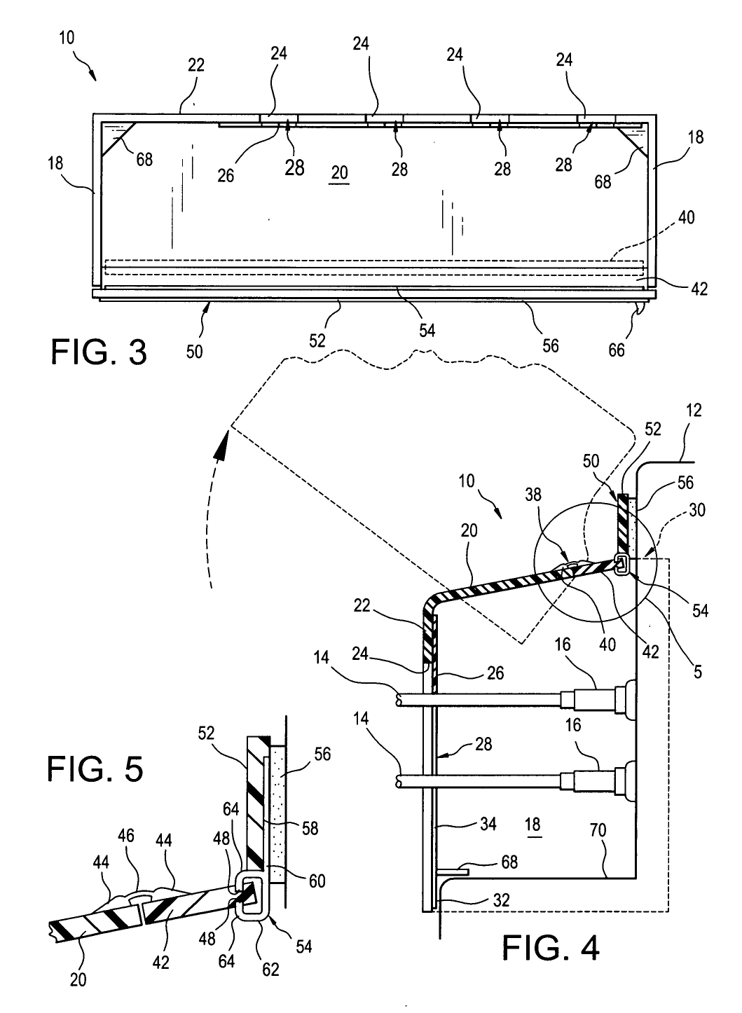

Similar reference characters denote corresponding features consistently throughout the accompanying drawings.

### DETAILED DESCRIPTION OF THE PREFERRED EMBODIMENT

Referring now to the FIGS., an electrical connector canopy 10 shown to be mounted on a telecommunications base station cabinet 12 to which coaxial cables 14 are joined by means of cable connectors 16. Canopy 10 includes two, spaced-apart end walls 18 that are connected together by a top wall 20. A front wall 22 is connected to, and extends downwardly from, top wall 20. A number of vertical slots 24 are provided in front wall 22 that extend upwardly from the bottom thereof. A resilient sheet 26 is affixed to front wall 22 to prevent the passage of animals, dirt, and precipitation through slots 24. Sheet 26 is, however, provided with elongated openings 28 that extend along the centerlines of slots 24 to provide for the snug passage of cables 14.

Each of end walls 18 is a generally rectangular piece of ABS plastic being about 0.25 inches (6 mm) thick. Each end wall 18 measures about 11 inches (28 cm) from top to bottom and measures about 9 inches (23 cm) from front to back. Of course, the dimensions of end walls 18 can be varied as a matter of design choice.

Top wall 20 is a rectangular piece of ABS plastic being about 0.25 inches (6 mm) thick. Top wall 20 measures about 35 inches (89 cm) from end to end and measures about 7 inches (18 cm) from front to back. The dimensions of top wall 20 can be varied as a matter of design choice.

The respective fronts of ends walls 18 and top wall 20 are coplanar. Since the front to back measurement of top wall 20 is less than that of end walls 18, a recess 30 is provided in canopy 10 adjacent top wall 20 for snugly receiving cabinet 12. Recess 30 measures about 34.5 inches (88 cm) by 2 inches (5 cm).

Like walls 18 and 20, front wall 22 is a formed from a piece of ABS plastic about 0.25 inches (6 cm) thick. Front wall 22 has the same length as top wall 20, measuring about 35 inches (89 cm) from end to end. Also, front wall 22 has about the same height as end walls 18, measuring about 11 inches (28 cm) from top to bottom. The dimensions of front wall 22 are a matter of design choice.

Front wall 22 is connects to top wall 20 and end walls 18. As shown, the top of front wall 22 is affixed to, and extends downwardly from, the front of top wall 20. Furthermore, the opposite ends of front wall 22 are affixed to, and extend inwardly from, the respective fronts of end walls 18.

Front wall 22 is provided with four slots 24 that are axially aligned with cable connectors 16 that join cabinet 12 in four columns. One of slots 24 is located midway between the ends of front wall 22 with an additional slot 24 being located to the left thereof (as seen in FIG. 2) and another pair of slots 24 being located to the right thereof (as seen in FIG. 2). Each of slots 24 is about 2 inches (5 cm) wide and 7 inches (18 cm) tall. Slots 24 are provided at intervals of 6 inches (15 cm), center to center. The dimensions and positions of slots 24 can be varied as a matter of design choice to accommodate connectors 16 that join cabinet 12 at different locations.

Resilient sheet 26 is adhesively fastened to the back of front wall 22 so as to be covered by top wall 20, and located within canopy 10, during use. Resilient sheet 26 is formed of stiff rubber about 0.125 inches (3 m) in thickness. Sheet 26 measures about 10.75 inches (27 cm) from top to bottom and measures about 25.5 inches (65 cm) from end to end. As shown, sheet 26 is positioned so as to close slots 24.

An elongated opening 28 is provided in resilient sheet 26 to bisect each of slots 24. Each opening 28 has a notch 32 at its bottom that tapers to a vertical slit 34 that is normally closed due to the resiliency of the rubber comprising sheet 26. Each opening 28 further includes a pair of bores 36 that pass through sheet 26 and slit 34 in a spaced-apart relationship. Each of bores 36 has a diameter of 0.625 inches (1.6 cm) that is adequate to provide for the snug passage of a cable 14 and is positioned so as to be axially aligned with one of cable connectors 16. Thus, during use of canopy 10, cables 14 extend straight from cabinet 12 and through openings 28 with sheet 26 relieving connectors 16 of some strain that may be placed upon cables 14 remote from cabinet 12.

Canopy 10 swings up and down relative to cabinet 12 by means of a hinge assembly 38. Assembly 38 includes a hinge 40 and a key plate 42. Hinge 40 is a unitary band of weather-resistant, acrylic plastic, measuring about 35 inches (89 cm) from end to end, that has a pair of relatively thick fastening belts 44 connected together along their respective lengths by a thin, flexible, medial web 46. One of belts 44 is adhesively fastened to the rear of top wall 20 and the other of belts 44 is similarly fastened to the front of key plate 42. Key plate 42, being formed from ABS plastic, measures about 35 inches (89 cm) in length, about 2 inches (5 cm) in width, and is about 0.25 inches (6 mm) thick. Key plate 42 has a pair of shallow, axially aligned grooves 48 at its rear end. One of grooves 48 is located in the top of plate 42 and extends the length of plate 42 and the other of grooves 48 is in the bottom of plate 42 and extends the length of plate 42.

A mounting assembly 50 releasably connects canopy 10 to cabinet 12. Mounting assembly 50 includes: a mounting plate 52, a mounting track 54 suspended from mounting plate 52, and a strip of double-sided adhesive tape 56 affixed to plate 52 and track 54. Plate 52, being formed from ABS plastic, measures about 34.5 inches (88 cm) in length, about 2 inches (5 cm) in width, and about 0.25 inches (6 mm) in thickness. A shallow recess 58 measuring about 34.5 inches (88 cm) by 0.0625 inches (2 mm) by 1 inch (2.5 cm) is provided in the back of plate 52 into which is fitted and adhesively affixed the retaining flange 60 of track 54. Being affixed to, and projecting downwardly and forwardly from, the bottom of flange 60 is a C-shaped guide rail 62 that measures about 34.5 inches (88 cm) from end to end. As shown, rail 62 has a pair of elongated and opposed fingers 64 at its opposite ends that are adapted to slide smoothly within grooves 48. Plate 52 and flange 60 carry on their respective back sides an elongated piece of weather-resistant, double-sided tape 56. Prior to use, tape 56 is prevented from adhering to extraneous objects by means of a peel-away, release liner 66 applied to tape 56 at the time of its manufacture. Mounting of canopy 10 is afforded simply by pressing tape 56 against cabinet 12 at an appropriate location.

A pair of gussets 68, being formed of ABS plastic, stabilizes and reinforces canopy 10. Each of gussets 68 is placed at the junction of a respective one of end walls 18 and front wall 22 about 2 inches (5 cm) from the bottom of canopy 10. After installation of canopy 10 on cabinet 12, gussets 68 rest on cabinet 12 and transmit some of the weight that would otherwise be borne by tape 56 directly to a cabinet ledge 70 protruding beneath connectors 16.

The installation of canopy 10 on cabinet 12 is straightforward. First, canopy 10 is positioned above connectors 16 protruding from cabinet 12. Next, elongated openings 28 in resilient sheet 26 are axially aligned with the correspondingly positioned cables 14 projecting from connectors 16. Then, canopy 10 is slowly lowered while all of cables 14 are worked upwardly through openings 28, i.e. from notch 32 to slit 34 to one of bores 36, such that cables 14 pass horizontally from connectors 16 through sheet 26 and gussets 68 rest upon cabinet ledge 70. Finally, release liner 66 is pulled away to expose tape 56 and tape 56 is pressed against the side of cabinet 12 above connectors 16. Connectors 16 are now protected from environmental degradation by a canopy 10 that is: UV, water and impact resistant, electrically non-conductive, and inflammable.

Inspection of connectors 16 is easily made after installation of canopy 10 simply by lifting front wall 22 gently so as to pivot top wall 20 upon hinge 40. While lifting is being accomplished, cables 14 slide free of bores 36 and downwardly through slits 34 and outwardly from notches 32. Afterward, with front wall 22 being manually held in an elevated position and cables 14 being free of resilient sheet 26, connectors 16 can be easily observed, accessed and checked.

If a user needs to access connectors 16 for a prolonged period, canopy 10 is detached from cabinet 12. Detachment is accomplished simply by sliding key plate 42 from guide rail 62. Sliding is, of course, made possible by the friction fit between rail fingers 64 and grooves 48 in key plate 42. Once detached from cabinet 12, canopy 10 is set aside in a secure area where it cannot be tripped over, damaged or lost.

Repositioning of canopy 10 on cabinet 12 is accomplished by sliding key plate 42 fully into rail 62. Next, front wall 22 is pushed downwardly so that cables 14 pass upwardly through openings 28 and into bores 36. Once gussets 68 rest upon cabinet ledge 70, reinstallation of canopy 10 is complete. Connectors 16 are effectively protected from weathering by canopy 10 to an unprecedented degree.

While electrical connector canopy 10 has been described with a high degree of particularity, it will be appreciated by those skilled in the art that modifications can be made to it. For example, the number and location of slots 24 as well as the number of location of bores 36 can be varied as a matter of design choice. Therefore, it is to be understood that the present invention is not limited solely to canopy 10 described above, but encompasses any and all canopies within the scope of the following claims.

1: An electrical connector canopy, comprising:
a pair of spaced-apart, end walls;
a top wall extending between and connecting together said end walls;
a front wall extending downwardly from and being connected to said top wall, said front wall being provided with a plurality of vertical slots extending upwardly from the bottom thereof; and,
a resilient sheet being affixed to said front wall, said sheet being provided with a plurality of elongated openings that extend along the centerlines of said slots.

2: The electrical connector canopy according to claim 1 further comprising:
a mounting plate adapted for attachment to a base station cabinet; and,
a hinge pivotally connecting said top wall to said mounting plate.

3: The electrical connector canopy according to claim 2 further comprising:
a C-shaped guide rail being affixed to said mounting plate; and,
a key plate being slidably and releasably engaged with said guide rail; and,
said hinge being affixed to said top wall and said key plate.

4: The electrical connector canopy according to claim 1 further comprising a pair of gussets, each of said gussets being affixed to said front wall and a respective one of said end walls a location being below the top of said slots.

5: The electrical connector canopy according to claim 1 wherein each of said elongated openings in said resilient sheet includes:
a tapered notch at the bottom thereof;
a vertical slit extending upwardly from the top of said notch; and,
at least one bore, being relatively wider than said slit, intersecting said slit for the snug passage of a cable.

6: An electrical connector canopy, comprising:
a pair of spaced-apart, end walls;
a top wall extending between and connecting together said end walls;
a front wall extending downwardly from and being connected to said top wall, said front wall being provided with a plurality of vertical slots extending upwardly from the bottom thereof;
a resilient sheet being affixed to said front wall, said sheet being provided with a plurality of elongated openings that extend along the centerlines of slots, each of said elongated openings including:
a vertical slit; and,
at least one bore, being relatively wider than said slit, intersecting said slit for the snug passage of a cable;
a mounting plate adapted for attachment to a vertical supporting surface; and,
a hinge pivotally connecting said top wall to said mounting plate.

7: An electrical connector canopy, comprising:
a pair of spaced-apart, end walls;
a top wall extending between and connecting together said end walls;
a front wall extending downwardly from and being connected to said top wall, said front wall being provided with a plurality of vertical slots extending upwardly from the bottom thereof;
a resilient closure being affixed to said front wall, said closure being provided with a plurality of elongated openings that extend along the centerlines of slots;
a mounting plate adapted for attachment to a vertical supporting surface; and,
a hinge pivotally connecting said top wall to said mounting plate.
